(19) United States
(12) Patent Application Publication
(10) Pub. No.: US 2010/0128177 A1
(43) Pub. Date: May 27, 2010

(54) SIGNAL PROCESSING UNITS CAPABLE OF PROVIDING PLUG-IN DETECTION

(75) Inventors: Kuan-Hung Chen, Taipei County (TW); Wen-Chin Hsieh, Hsinchu City (TW); Yen-Hsun Hsu, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/277,475

(22) Filed: Nov. 25, 2008

(51) Int. Cl. H04N 5/46

(52) U.S. Cl. 348/558; 348/E05.114

(57) ABSTRACT

Signal processing units capable of providing plug-in detection without an external circuit occupying GPIO resource are provided, in which a switching element is coupled to a television signal output pad, a terminal resistor is coupled between the switching element and a ground voltage, and an interrupt signal generator generates an interrupt signal when a receiving port of a television signal receiver is coupled to the television signal pad. A control unit turns on the switching element to connect the terminal resistor to the television signal output pad when receiving the interrupt signal, wherein the switching element, the terminal resistor, the interrupt signal generator and the control unit are integrated in a chip.

### BACKGROUND OF THE INVENTION

1. Field of the Invention

The invention relates to plug-in detection, and more particularly, to signal processing units capable of providing plug-in detection without an external circuit occupying GPIO resource.

2. Description of the Related Art

As is known, audio signals are processed by a wide variety of electronic equipment, including portable, or handheld, devices. Such devices include laptop, notebook and other personal computers, personal digital assistants (PDA), CD players, MP3 players, DVD players, AM/FM radio, satellite radio systems, in-band on channel digital radios, cellular telephones, consumer audio equipment such as stereo systems, home theater systems, cable and satellite tuners and set-top boxes, digital video recorders and other systems that support the processing of audio and video, etc. Each of these devices includes one or more integrated circuits to provide the functionality of the device. As an example, a computer may include an audio codec or other audio input-output modules to support the processing of audio signals in order to produce an audio output that is delivered to the user through speakers, headphones or the like and/or to receive audio signals from an external device such as a microphone, CD player or other source of analog or digital audio signals.

A problem common for many of these devices is that many are equipped with multiple jacks for coupling signals such as audio input/output signals to and from the device. A user of the device may connect or disconnect these jacks while the device is in operation, either to discontinue the use of a connection or to couple a new peripheral or signal to the device. It is desirable to detect that a device or signal has been coupled or decoupled from each of the plurality of jacks in a manner that can be efficiently implemented in an electronic device.

### BRIEF SUMMARY OF THE INVENTION

Embodiments of a signal processing unit with plug-in detection are provided, in which a switching element is coupled to a television signal output pad, a terminal resistor is coupled between the switching element and a ground voltage, and an interrupt signal generator generates an interrupt signal when a receiving port of a television signal receiver is coupled to the television signal pad. A control unit turns on the switching element to connect the terminal resistor to the television signal output pad when receiving the interrupt signal, wherein the switching element, the terminal resistor, the interrupt signal generator and the control unit are integrated in a chip.

The invention provides an embodiment of an electronic device, in which a signal processing chip interacts with a television signal receiver, and the signal processing chip comprises a switching element coupled to a television signal output pad, a terminal resistor coupled between the switching element and a ground voltage, an interrupt signal generator generating an interrupt signal when a receiving port of the television signal receiver is coupled to the television signal pad, and a control unit turning on the switching element to connect the terminal resistor to the television signal output pad when receiving the interrupt signal.

The invention provides an embodiment of a plug-in detection method, in which a voltage level on a television signal output pad of a chip is detected by an interrupt signal generator in the chip to determine whether the television signal output pad is coupled to a receiving port of a television signal receiver, and a switching element in the chip is turned on when the television signal output pad is coupled to the receiving port of the television signal receiver, such that the television signal output pad is coupled to a ground voltage through a terminal resistor in the chip.

### BRIEF DESCRIPTION OF THE DRAWINGS

The invention can be more fully understood by reading the subsequent detailed description and examples with references made to the accompanying drawings, wherein:

FIG. 1 shows an embodiment of an electronic device;

FIG. 2 shows another embodiment of the signal processing chip; and

FIG. 3 shows another embodiment of the signal processing chip.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Certain terms are used throughout the description and claims to refer to particular system components. As one skilled in the art will appreciate, consumer electronic equipment manufacturers may refer to a component by different names. This document does not intend to distinguish between components that differ in name but not function.

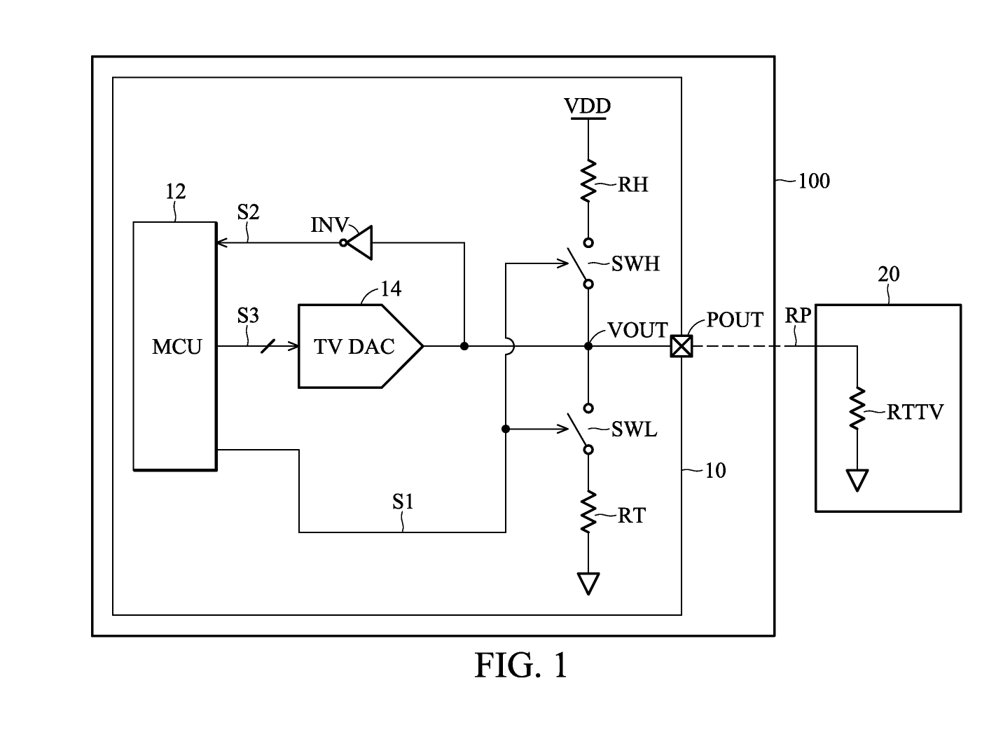

FIG. 1 shows an embodiment of an electronic device. As shown, the electronic device 100 comprises a signal processing chip (also called signal processing unit) 10 capable of interacting with a television signal receiver 20. For example, the electronic device 100 can be a mobile phone, a smart phone, a digital camera, a personal digital assistant (PDA), a notebook computer, a desktop computer, a tablet personal computer (PC) or a portable DVD player, but is not limited thereto.

The signal processing chip 10 comprises a micro processing unit 12, a television digital-to-analog converter (TV DAC) 14, an inverter INV, resistors RH and RT, switching elements SWH and SWL, and a television signal output pad POUT. The signal processing chip 10 performs a plug-in detection before transmitting television signals, and transmits television signals to the television signal receiver 20 after a receiving port RP of the television signal receiver 20 is coupled to the television signal output pad POUT. The television signal receiver 20 can, for example, be a display, such as a television, a car display, a monitor and the like.

The resistor RH comprises a first terminal coupled to a power voltage VDD, and a second terminal coupled to the switching element SWH. The switching element SWH comprises a first terminal coupled to the resistor RH, and a second terminal coupled to the television signal output pad POUT. The switching element SWL comprises a first terminal coupled to the television signal output pad POUT, and a second terminal coupled to the resistor RT, and the switching elements SWH and SWL are controlled by the micro processing unit 12. The resistor RT is coupled between the second terminal of the switching element SWL and a ground voltage.

The inverter INV is coupled between the television signal output pad POUT to serve as an interrupt signal generator. The inverter INV comprises an input terminal coupled to the television signal output pad POUT, and an output terminal coupled to the micro processing unit 12. The inverter INV generates an interrupt signal S2 according to a voltage level VOUT on the television signal output pad POUT. For example, the inverter INV generates the interrupt signal S2 with a logic low when the voltage level VOUT on the television signal output pad POUT is at a logic high. On the contrary, the inverter INV generates the interrupt signal S2 with a logic high when the voltage level VOUT on the television signal output pad POUT is at a logic low.

The micro processing unit 12 controls operations of the TV DAC 14 and the switching elements SWH and SWL. For example, the micro processing unit 12 switches the switching elements SWH and SWL according to the interrupt signal S2 and transmits a television signal S3 to the television signal receiver 20 through the TV DAC 14 after the television signal receiver 20 is coupled to the television signal output pad POUT. The television signal S3 can be a digital television signal. The TV DAC 14 converts the television signal S3 from the micro processing unit 12 to an analog television signal and output to the television signal receiver 20.

A method for plug-in detection in the signal processing chip 10 is illustrated hereinafter. Initially, the micro processing unit 12 outputs a control signal S1 to turn on the switching element SWH and turn off the switching element SWL. As a result, the voltage level VOUT at television signal output pad POUT is electrically separated from the ground voltage and is pulled high by the power voltage VDD. Because the television signal output pad POUT is pulled high, the interrupt signal S2 from the inverter INV is at a logic low.

When the receiving port RP of the television signal receiver 20 is plugged in (i.e., the receiving port RP is coupled to the television signal output pad POUT of the electronic device 100), the voltage level VOUT at television signal output pad POUT is pulled low by the resistor RTTV in the television signal receiver 20. As a result, the interrupt signal S2 from the inverter INV becomes a logic high. As the interrupt signal S2 is at a logic high, the micro processing unit 12 turns the switching elements SWH and SWL off and on respectively by the control signal S1. Consequently, the television signal output pad POUT is electrically separated from the power voltage VDD and is coupled to the ground voltage through the terminal resistor RT.

After that, the micro processing unit 12 can provide the television signal S3 to the TV DAC 14, and then the TV DAC 14 converts the television signal S3 into an analog television signal and outputs to the television signal receiver 20 through the television signal output pad POUT. After TV DAC 14 finishes its operations or the receiving port RP of the television signal receiver 20 is decoupled from the television signal output pad POUT, the micro processing unit 12 turns the switching elements SWH and SWL on and off, respectively. In embodiments of the invention, the terminal resistor RT can be a variable resistor, but is not limited thereto.

Because the inverter INV can enable the micro processing unit to switch the switching elements SWH and SWL according to the connection of the receiving port RP of the television signal receiver 20, the plug-in detection is obtained without an external circuit occupying GPIO resource.

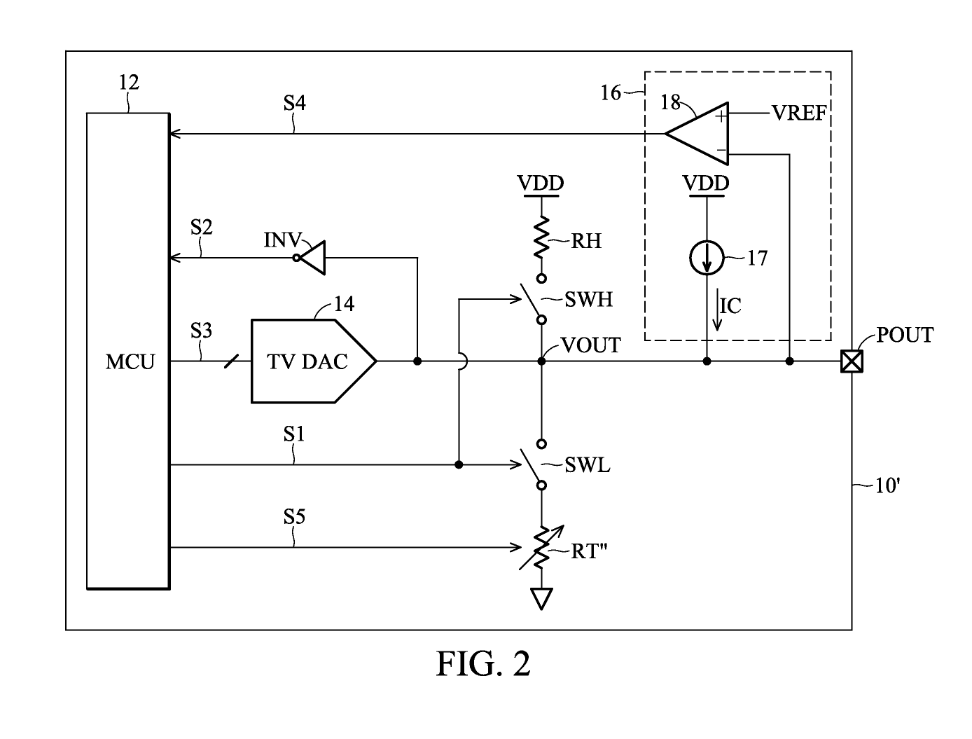

FIG. 2 shows another embodiment of the signal processing chip. As shown, the signal processing chip 10′ is similar to the signal processing chip 10 shown in FIG. 1, differing only, in that the terminal resistor RT in FIG. 1 is replaced with a variable terminal resistor RT″, and a calibration circuit 16 is added for calibrating the variable terminal resistor RT″. Operations for Plug-in detection in the signal processing chip 10′ are similar to that in the signal processing chip 10 illustrated above, and thus, are omitted for simplification.

The calibration circuit 16 comprises a fixed current 17 and a comparator 18. During a calibration period, the micro processing unit 12 turns the switching elements SWH and SWL off and on respectively by the control signal S1 and the fixed current 17 provides an accurate reference current IC to the terminal resistor RT″. The comparator 18 compares the voltage level VOUT with a reference voltage VERF, and outputs a result signal S4 to the control unit 12. Because the voltage level VOUT at the television signal output pad POUT is in direct ratio to the product of the reference current IC and the terminal resistor RT″, the control unit 12 calibrates the terminal resistor RT″ according to the result signal S4. For example, the micro processing unit 12 outputs a signal S5 to decrease the resistance of the terminal resistor RT″ when the voltage level VOUT exceeds the reference voltage VERF. On the contrary, the micro processing unit 12 outputs the signal S5 to increase the resistance of the terminal resistor RT″ when the voltage level VOUT is lower than the reference voltage VERF.

It should be noted that, the current source 17 and the comparator 18 can be electrically separated from the television signal output pad POUT after calibration for the terminal resistor RT″ is accomplished. For example, two switching elements can be disposed between the current source 17 and the television signal output pad POUT and between the comparator 18 and the television signal output pad POUT respectively. When such calibration is accomplished, the micro processing unit 12 controls the switching elements to electrically separate the current source 17 and the comparator 18 from the television signal output pad POUT.

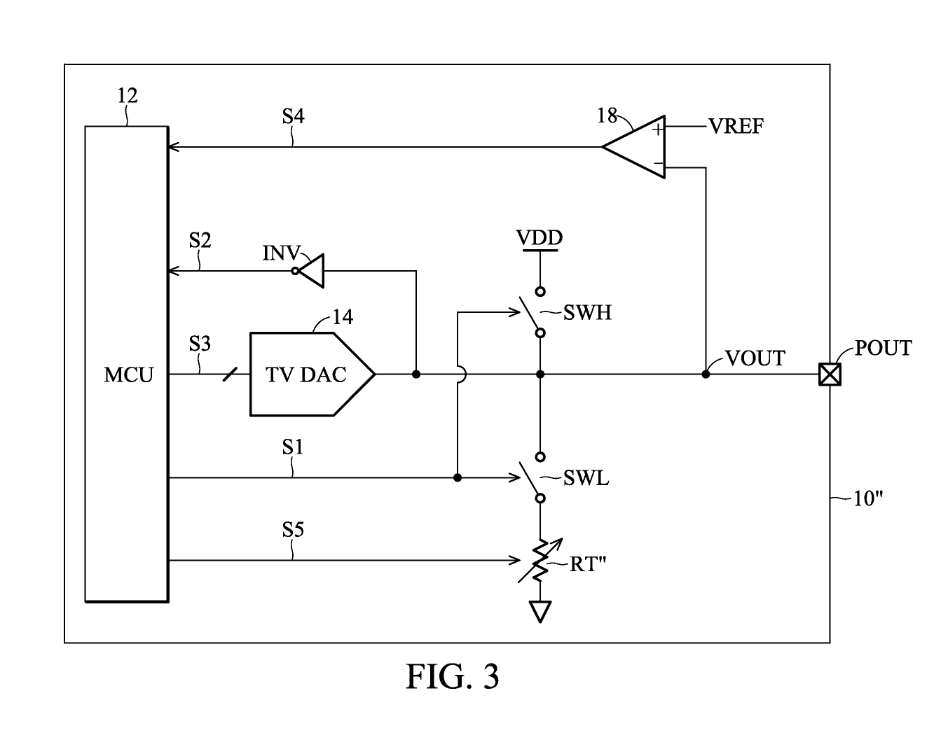

FIG. 3 shows another embodiment of the signal processing chip. As shown, the signal processing chip 10″ is similar to the signal processing chip 10′ shown in FIG. 2, differing only, in that the current source 17 is omitted. Operations for Plug-in detection in the signal processing chip 10″ are similar to that in the signal processing chip 10 illustrated in FIG. 1, and thus, are omitted for simplification.

During a calibration period, the micro processing unit 12 turns the switching elements SWH and SWL off and on respectively by the control signal S1, and then enables the TV DAC 14 to output a current signal (not shown) to the terminal resistor RT″. The comparator 18 compares the voltage level VOUT with a reference voltage VERF, and outputs a result signal S4 to the control unit 12. Because the voltage level VOUT at the television signal output pad POUT is in direct ratio to the product of the current signal from the TV DAC 14 and the terminal resistor RT″, the control unit 12 calibrates the terminal resistor RT″ according to the result signal S4. For example, the micro processing unit 12 outputs a signal S5 to decrease the resistance of the terminal resistor RT″ when the voltage level VOUT exceeds the reference voltage VERF. On the contrary, the micro processing unit 12 outputs the signal S5 to increase the resistance of the terminal resistor RT″ when the voltage level VOUT is lower than the reference voltage VERF.

It should be noted that, the comparator 18 can be electrically separated from the television signal output pad POUT after calibration for the terminal resistor RT″ is accomplished. For example, a switching element can be disposed between the comparator 18 and the television signal output pad POUT. When such calibration is accomplished, the micro processing unit 12 controls the switching element to electrically separate the comparator 18 from the television signal output pad POUT.

Although the invention has been described in terms of preferred embodiment, it is not limited thereto. Those skilled in the art can make various alterations and modifications without departing from the scope and spirit of the invention. Therefore, the scope of the invention shall be defined and protected by the following claims and their equivalents.

What is claimed is:

1. A signal processing unit with plug-in detection, comprising:
a switching element coupled to a television signal output pad;
a terminal resistor coupled between the switching element and a ground voltage;
an interrupt signal generator generating an interrupt signal when a receiving port of a television signal receiver is coupled to the television signal pad; and
a control unit turning on the switching element to connect the terminal resistor to the television signal output pad when receiving the interrupt signal, wherein the switching element, the terminal resistor, the interrupt signal generator and the control unit are integrated in a chip.

2. The signal processing unit as claimed in claim 1, further comprising a pull-high circuit pulling high the television signal output pad when the receiving port is not coupled to the television signal pad.

3. The signal processing unit as claimed in claim 2, wherein the control unit enables the pull-high circuit to stop pulling high the television signal output pad when receiving the interrupt signal.

4. The signal processing unit as claimed in claim 1, further comprising a digital-to-analog converter transmitting a television signal to the television signal receiver through the television signal output pad after the terminal resistor is connected to the television signal output pad.

5. The signal processing unit as claimed in claim 1, wherein, during a calibration period, the control circuit connects the terminal resistor to the television signal output pad and enables the digital-to-analog converter to output a current signal to the terminal resistor, and the signal processing unit further comprises a comparator comparing a voltage level at the television signal output pad with a reference voltage and outputting a result signal during the calibration period, such that the control unit calibrates the terminal resistor according to the result signal.

6. The signal processing unit as claimed in claim 1, wherein the interrupt signal generator comprises an inverter comprising an input terminal coupled to the television signal output pad and an output terminal outputting the interrupt signal to the control unit.

7. The signal processing unit as claimed in claim 1, further comprising:
a current source providing a reference current to the television signal output pad when the terminal resistor is connected to the television signal output pad during a calibration period; and
a comparator comparing a voltage level at the television signal output pad with a reference voltage and outputting a result signal, such that the control unit calibrates the terminal resistor according to the result signal.

8. An electronic device, comprising:
a signal processing chip interacting with a television signal receiver, wherein the signal processing chip comprises:
a switching element coupled to a television signal output pad;
a terminal resistor coupled between the switching element and a ground voltage;
an interrupt signal generator generating an interrupt signal when a receiving port of the television signal receiver is coupled to the television signal pad; and
a control unit turning on the switching element to connect the terminal resistor to the television signal output pad when receiving the interrupt signal.

9. The electronic device as claimed in claim 8, wherein the signal processing chip further comprises a pull-high circuit pulling high the television signal output pad when the receiving port is not coupled to the television signal pad.

10. The electronic device as claimed in claim 9, wherein the control unit enables the pull-high circuit to stop pulling high the television signal output pad when receiving the interrupt signal.

11. The electronic device as claimed in claim 9, wherein the interrupt signal generator comprises an inverter comprising an input terminal coupled to the television signal output pad and an output terminal outputting the interrupt signal to the control unit.

12. The electronic device as claimed in claim 9, wherein the signal processing chip further comprises a digital-to-analog converter transmits a television signal to the television signal receiver through the television signal output pad after the terminal resistor is connected to the television signal output pad.

13. The electronic device as claimed in claim 12, wherein, during a calibration period, the control circuit connects the terminal resistor to the television signal output pad and enables the digital-to-analog converter to output a current signal to the terminal resistor, and the signal processing chip further comprises a comparator comparing a voltage level at the television signal output pad with a reference voltage and outputting a result signal during the calibration period, such that the control unit calibrates the terminal resistor according to the result signal.

14. The electronic device as claimed in claim 12, wherein the signal processing chip further comprises:
a current source providing a reference current to the television signal output pad when the terminal resistor is connected to the television signal output pad during a calibration period; and
a comparator comparing a voltage level at the television signal output pad with a reference voltage and outputting a result signal, such that the control unit calibrates the terminal resistor according to the result signal.

15. The electronic device as claimed in claim 8, wherein the electronic device is a mobile phone, a smart phone, a digital camera, a personal digital assistant (PDA), a notebook computer, a desktop computer, a tablet personal computer (PC) or a portable DVD player.

16. A plug-in detection method, comprising:
detecting a voltage level on a television signal output pad of a chip by an interrupt signal generator in the chip to determine whether the television signal output pad is coupled to a receiving port of a television signal receiver; and
turning on a switching element in the chip when the television signal output pad is coupled to the receiving port of the television signal receiver, such that the television signal output pad is coupled to a ground voltage through a terminal resistor in the chip.

17. The plug-in detection method as claimed in claim 16, further comprising generating an interrupt signal when the television signal output pad is coupled to the receiving port of the television signal receiver.

18. The plug-in detection method as claimed in claim 17, further comprising
enabling a pull high circuit in the chip to pull high the television signal output pad when the television signal output pad is not coupled to the receiving port of the television signal receiver; and
to stop pulling high the television signal output pad when receiving the interrupt signal.

19. The plug-in detection method as claimed in claim 17, wherein the interrupt signal is an inverse signal of the voltage level on the television signal output pad.

20. The plug-in detection method as claimed in claim 16, further comprising turning off the switching element when the receiving port of the television signal receiver is decoupled from the television signal output pad.
